(19) United States
(12) Patent Application Publication
(10) Pub. No.: US 2023/0007961 A1
(43) Pub. Date: Jan. 12, 2023

(54) TEMPERATURE MEASURING DEVICE AND TEMPERATURE MEASURING METHOD FOR PROVIDING LIGHT SPOT MARKS OF DIFFERENT COLORS

(71) Applicant: RADIANT INNOVATION INC., Hsinchu County (TW)

(72) Inventors: YUNG-CHANG CHANG, HSINCHU COUNTY (TW); FENG-LIEN HUANG, HSINCHU CITY (TW)

(21) Appl. No.: 17/369,959

(22) Filed: Jul. 8, 2021

(51) Int. Cl. G01K 11/125

(52) U.S. Cl. CPC G01K 11/125

(57) ABSTRACT

A temperature measuring device and a temperature measuring method for providing light spot marks of different colors are provided. The temperature measuring device includes a temperature measuring main body, a signal-providing module, a temperature-sensing module, and a first and a second color projection module. The signal-providing module and the temperature-sensing module are disposed on the temperature measuring main body. The temperature-sensing module is configured for measuring a temperature of a target area of an object. The first color projection module is disposed on the temperature measuring main body, and configured for projecting a first color light beam onto the target area of the object by control of the signal-providing module. The second color projection module is disposed on the temperature measuring main body, and configured for projecting a second color light beam onto the target area of the object by control of the signal-providing module.

### FIELD OF THE DISCLOSURE

The present disclosure relates to a temperature measuring device and a temperature measuring method, and more particularly to a temperature measuring device and a temperature measuring method for providing light spot marks of different colors.

### BACKGROUND OF THE DISCLOSURE

In the related art, a temperature measuring device has been widely used for measuring temperature. However, measurement position accuracy of the temperature measuring device during temperature measurement (whether the temperature measuring device is accurately aimed at an area to be measured) still has room for improvement.

### SUMMARY OF THE DISCLOSURE

In response to the above-referenced technical inadequacy, the present disclosure provides a temperature measuring device and a temperature measuring method for providing light spot marks of different colors.

In one aspect, the present disclosure provides a temperature measuring device for providing light spot marks of different colors, which includes a temperature measuring main body, a signal control module, a signal-providing module, a temperature-sensing module, a first color projection module, and a second color projection module. The signal control module is disposed on the temperature measuring main body. The signal-providing module is disposed on the temperature measuring main body and electrically connected to the signal control module. The temperature-sensing module is disposed on the temperature measuring main body and electrically connected to the signal control module, and is configured for measuring a temperature of a target area of an object in a temperature-sensing range. The first color projection module is disposed on the temperature measuring main body and electrically connected to the signal control module, and is configured for projecting a first color light beam onto the target area of the object by control of the signal-providing module. The second color projection module is disposed on the temperature measuring main body and electrically connected to the signal control module, and is configured for projecting a second color light beam onto the target area of the object by control of the signal-providing module. The temperature-sensing range extends along a temperature-sensing optical axis, and heat radiation generated by the target area of the object is transmitted along the temperature-sensing optical axis and is then received by the temperature-sensing module. When the first color projection module is configured to project the first color light beam, the first color light beam projected by the first color projection module is transmitted along a first projecting optical axis so as to form a first light spot mark that is projected onto the target area of the object. When the second color projection module is configured to project the second color light beam, the second color light beam projected by the second color projection module is transmitted along a second projecting optical axis so as to form a second light spot mark that is projected onto the target area of the object. The first projecting optical axis and the temperature-sensing optical axis are inclined to each other and coincide at a first coincidence point, the second projecting optical axis and the temperature-sensing optical axis are inclined to each other and coincide at a second coincidence point, and a distance from the first coincidence point to the temperature-sensing module is smaller than a distance from the second coincidence point to the temperature-sensing module.

In another aspect, the present disclosure provides a temperature measuring method for providing light spot marks of different colors, which includes: providing distance information or temperature information according to a target area that is selected from an object; using a signal-providing module to turn on one of a first color projection module and a second color projection module according to the distance information or the temperature information; projecting a first color light beam by the first color projection module to form a first light spot mark on the target area of the object when the first color projection module is turned on, or projecting a second color light beam by the second color projection module to form a second light spot mark on the target area of the object when the second color projection module is turned on; and measuring a temperature of the target area of the object by a temperature-sensing module according to one of the first light spot mark provided by the first color projection module and the second light spot mark provided by the second color projection module.

In yet another aspect, the present disclosure provides a temperature measuring device for providing light spot marks of different colors, which includes a temperature measuring main body, a signal-providing module, a temperature-sensing module, a first color projection module, and a second color projection module. The signal-providing module is disposed on the temperature measuring main body. The temperature-sensing module is disposed on the temperature measuring main body, and is configured for measuring a temperature of a target area of an object. The first color projection module is disposed on the temperature measuring main body, and is configured for projecting a first color light beam onto the target area of the object by control of the signal-providing module. The second color projection module is disposed on the temperature measuring main body, and is configured for projecting a second color light beam onto the target area of the object by control of the signal-providing module.

Therefore, in the temperature measuring device for providing light spot marks of different colors provided by the present disclosure, by virtue of “the signal-providing module being disposed on the temperature measuring main body”, “the temperature-sensing module being disposed on the temperature measuring main body, for measuring the temperature of the target area of the object”, “the first color projection module being disposed on the temperature measuring main body, for projecting the first color light beam onto the target area of the object by control of the signal-providing module” and “the second color projection module being disposed on the temperature measuring main body, for projecting the second color light beam onto the target area of the object by control of the signal-providing module”, the temperature of the target area of the object can be measured by the temperature-sensing module selectively according to one of the first light spot mark provided by the first color projection module and the second light spot mark provided by the second color projection module.

Furthermore, in the temperature measuring method for providing light spot marks of different colors provided by the present disclosure, by virtue of “providing the distance information or the temperature information according to the target area that is selected from the object”, “using the signal-providing module to turn on one of the first color projection module and the second color projection module according to the distance information or the temperature information” and “projecting the first color light beam by the first color projection module to form the first light spot mark on the target area of the object when the first color projection module is turned on, or projecting the second color light beam by the second color projection module to form the second light spot mark on the target area of the object when the second color projection module is turned on”, the temperature of the target area of the object can be measured by the temperature-sensing module selectively according to one of the first light spot mark provided by the first color projection module and the second light spot mark provided by the second color projection module.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a functional block diagram of a temperature measuring device for providing light spot marks of different colors according to the present disclosure;

FIG. 2 is a flowchart of a temperature measuring method for providing light spot marks of different colors of the present disclosure;

FIG. 3 is a functional block diagram of the temperature measuring device for providing light spot marks of different colors according to a first embodiment of the present disclosure;

FIG. 4 is a schematic view of a temperature-sensing module of the temperature measuring device providing a temperature-sensing range that extends along a temperature-sensing optical axis according to the first embodiment of the present disclosure;

FIG. 5 is a schematic view of a first color projection module of the temperature measuring device projecting a first color light beam that is transmitted along a first projecting optical axis according to the first embodiment of the present disclosure;

FIG. 6 is a schematic view of a second color projection module of the temperature measuring device projecting a second color light beam that is transmitted along a second projecting optical axis according to the first embodiment of the present disclosure;

FIG. 7 is a schematic view of the first color projection module of the temperature measuring device projecting the first color light beam to form a first light spot mark on a target area of an object according to the first embodiment of the present disclosure;

FIG. 8 is a schematic view of the second color projection module of the temperature measuring device projecting the second color light beam to form a second light spot mark on the target area of the object according to the first embodiment of the present disclosure;

FIG. 9 is a functional block diagram of the temperature measuring device for providing light spot marks of different colors according to a second embodiment of the present disclosure; and

FIG. 10 is a functional block diagram of the temperature measuring device for providing light spot marks of different colors according to a third embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

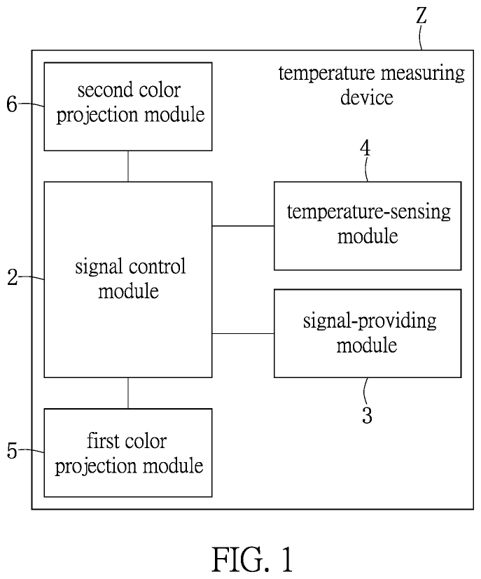

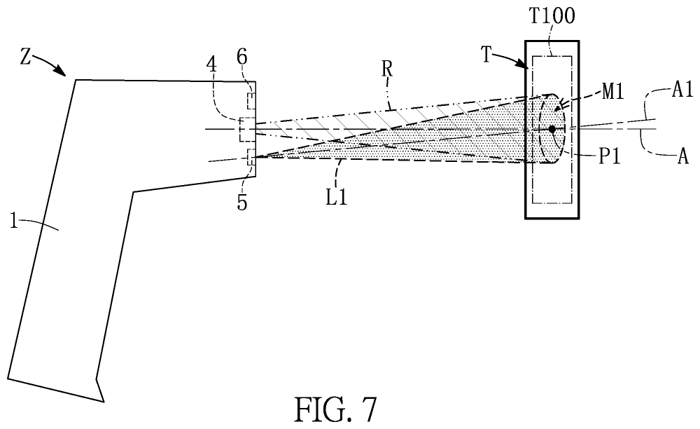

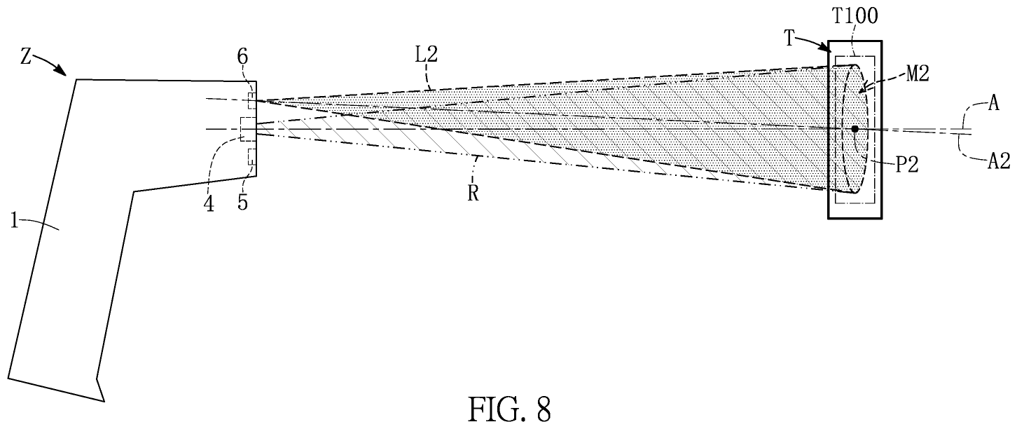

Referring to FIG. 1 to FIG. 10, the present disclosure provides a temperature measuring device Z for providing light spot marks of different colors, which includes a temperature measuring main body 1, a signal control module 2, a signal-providing module 3, a temperature-sensing module 4, a first color projection module 5, and a second color projection module 6. The signal-providing module 3 is disposed on the temperature measuring main body 1. The temperature-sensing module 4 is disposed on the temperature measuring main body 1, for measuring a temperature of a target area T100 of an object T that needs to be measured (under measurement). The first color projection module 5 is disposed on the temperature measuring main body 1, for projecting a first color light beam L1 onto the target area T100 of the object T (as shown in FIG. 7) by control of the signal-providing module 3 (such as cooperating with the signal control module 2). The second color projection module 6 is disposed on the temperature measuring main body 1, for projecting a second color light beam L2 onto the target area T100 of the object T (as shown in FIG. 8) by control of the signal-providing module 3 (such as cooperating with the signal control module 2).

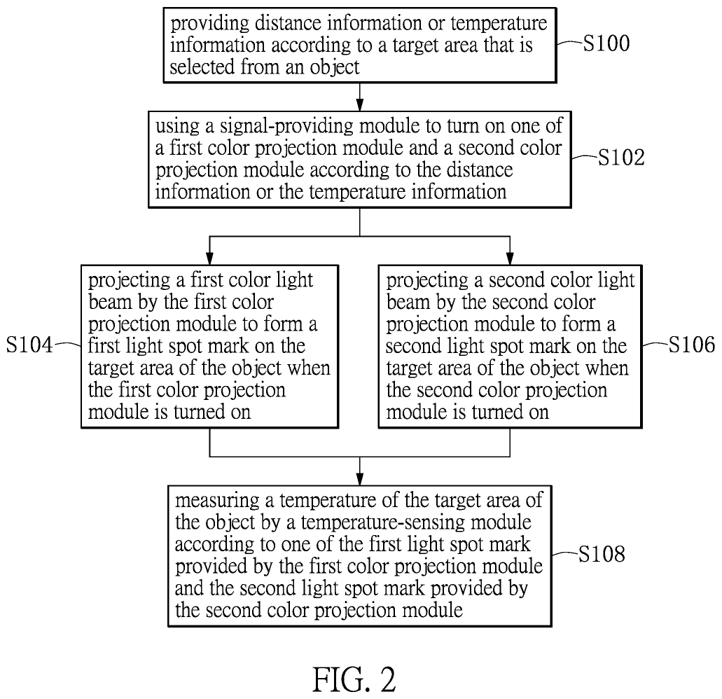

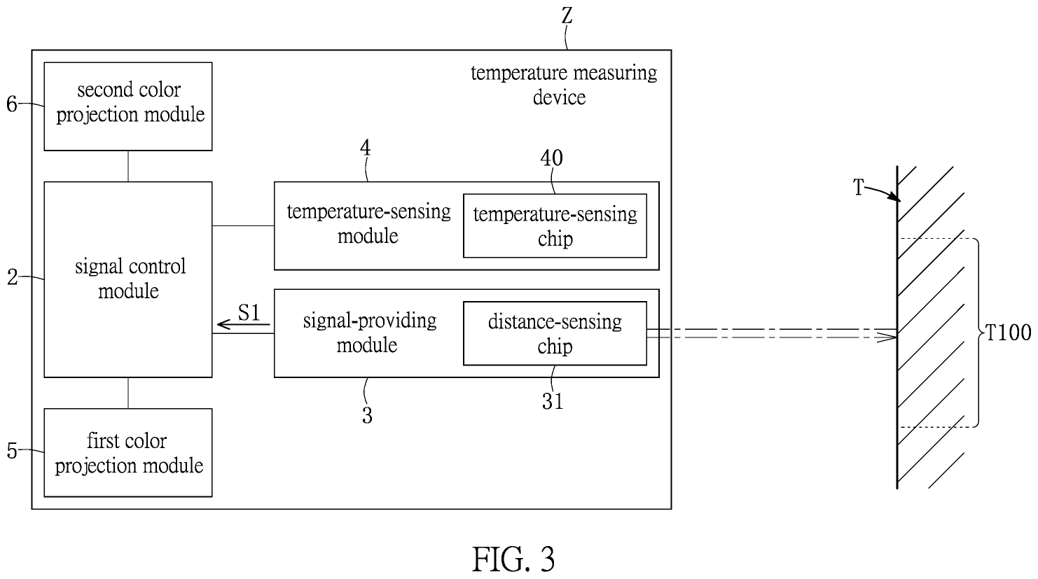

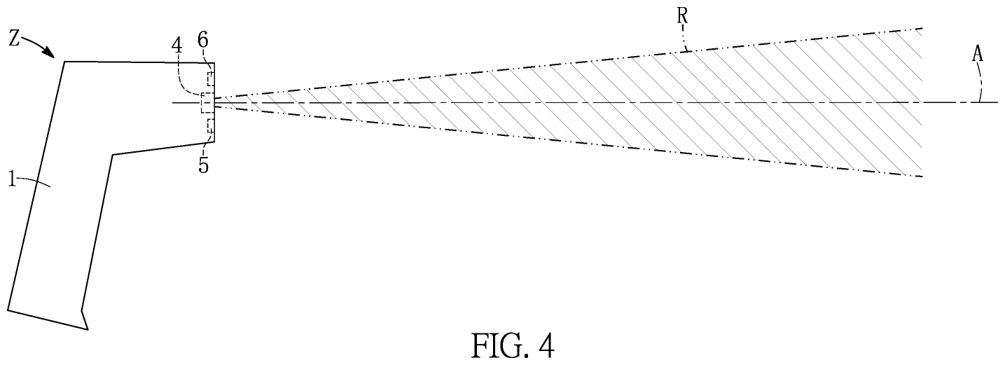

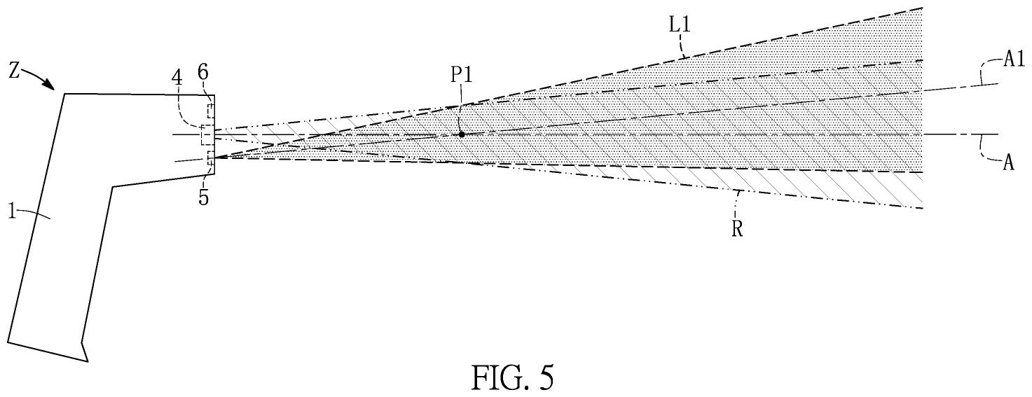

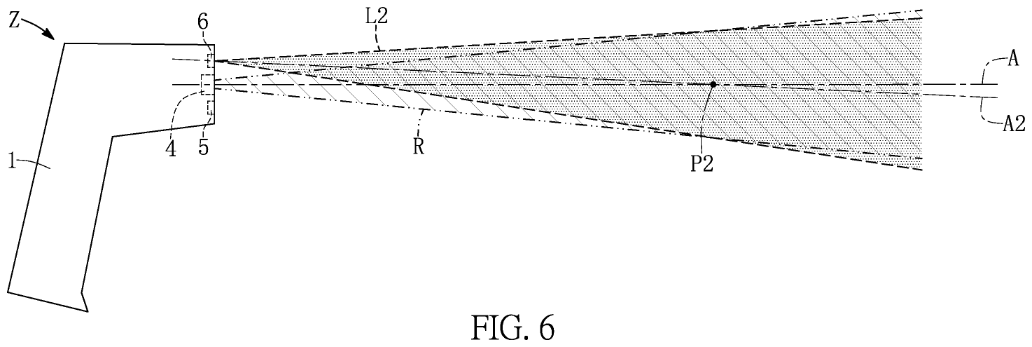

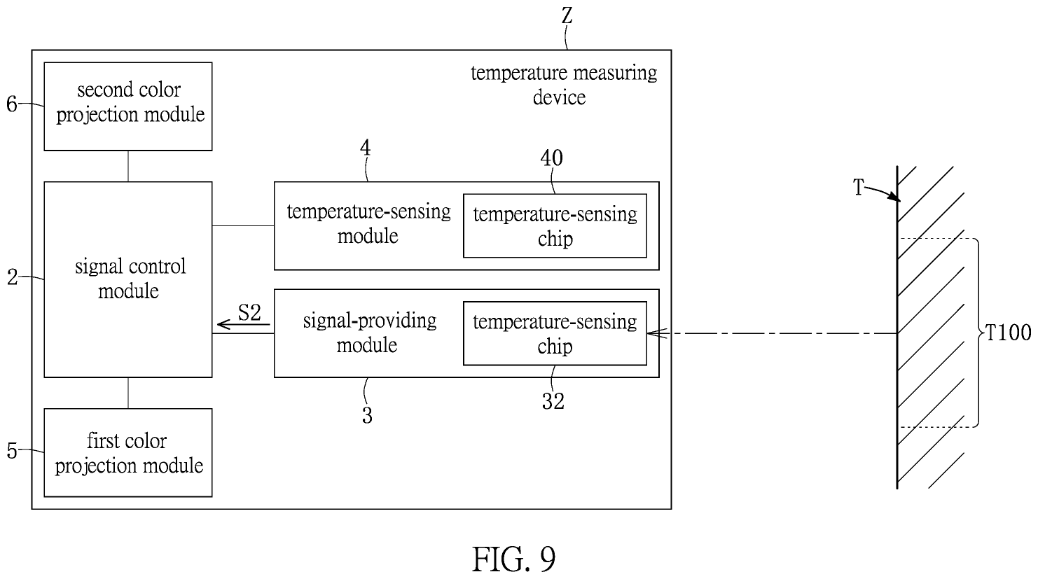

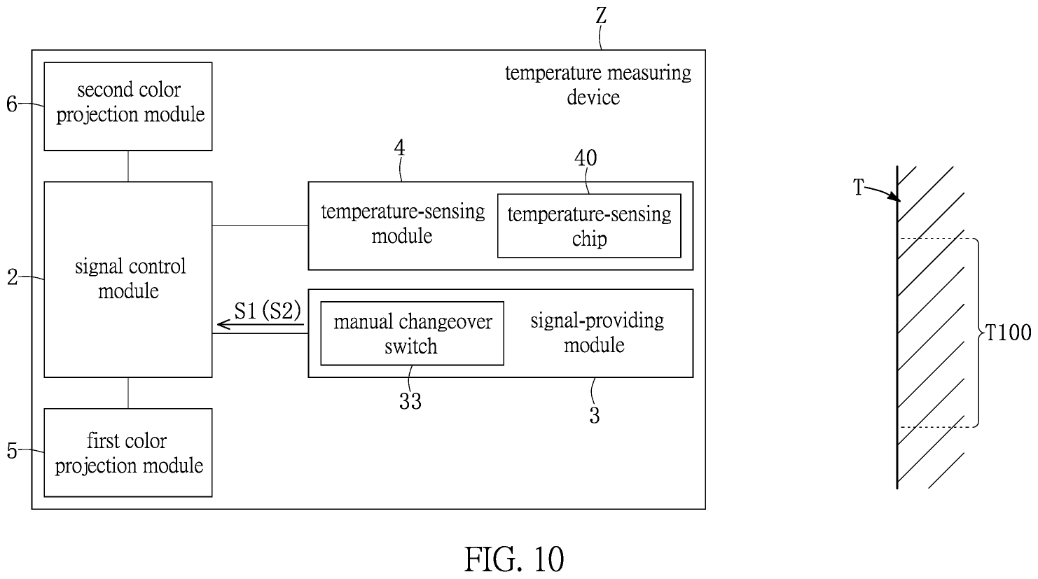

Referring to FIG. 1 to FIG. 10, the present disclosure provides a temperature measuring method for providing light spot marks of different colors, which includes: firstly, as shown in FIG. 2, FIG. 3, FIG. 9 and FIG. 10, providing distance information Si or temperature information S2 according to a target area T100 that is selected from an object T (step S100); next, as shown in FIG. 2, FIG. 3, FIG. 9 and FIG. 10, using a signal-providing module 3 (such as cooperating with a signal control module 2) to turn on one of a first color projection module 5 and a second color projection module 6 according to the distance information Si or the temperature information S2 (step S102); then, as shown in FIG. 2, FIG. 4, FIG. 5 and FIG. 7, projecting a first color light beam L1 by the first color projection module 5 to form a first light spot mark M1 on the target area T100 of the object T when the first color projection module 5 is turned on (step S104); alternatively, as shown in FIG. 2, FIG. 4, FIG. 6 and FIG. 8, projecting a second color light beam L2 by the second color projection module 6 to form a second light spot mark M2 on the target area T100 of the object T when the second color projection module 6 is turned on (step S106); and then, as shown in FIG. 7 or FIG. 8, measuring (or sensing) a temperature of the target area T100 of the object T by a temperature-sensing module 4 according to one of the first light spot mark M1 provided by the first color projection module 5 and the second light spot mark M2 provided by the second color projection module 6 (step S108).

### First Embodiment

Referring to FIG. 3 to FIG. 8, a first embodiment of the present disclosure provides a temperature measuring device Z for providing light spot marks of different colors, which includes a temperature measuring main body 1, a signal control module 2, a signal-providing module 3, a temperature-sensing module 4, a first color projection module 5, and a second color projection module 6. In addition, the signal control module 2, the signal-providing module 3, the temperature-sensing module 4, the first color projection module 5, and the second color projection module 6 are disposed on or inside the temperature measuring main body 1, and the signal-providing module 3, the temperature-sensing module 4, the first color projection module 5, and the second color projection module 6 are electrically connected to the signal control module 2.

More particularly, referring to FIG. 3, FIG. 4, FIG. 7 and FIG. 8, the temperature-sensing module 4 is disposed on the temperature measuring main body 1 and electrically connected to the signal control module 2, for measuring a temperature of a target area T100 of an object T in a temperature-sensing range R (e.g., a sensing range for a heat radiation source). In addition, the temperature-sensing range R can extend along a temperature-sensing optical axis A, and heat radiation (e.g., a heat radiation source) generated by the target area T100 of the object T can be transmitted along the temperature-sensing optical axis A and can then be received by the temperature-sensing module 4. For example, the signal-providing module 3 can be one of an automatic signal-providing module and a manual signal-providing module. In addition, the temperature-sensing module 4 includes a temperature-sensing chip 40 for sensing the heat radiation source, and the temperature-sensing module 4 can be a non-contact temperature-sensing module. However, the aforementioned description is merely an example, and is not meant to limit the scope of the present disclosure.

More particularly, referring to FIG. 3, FIG. 4, FIG. 5 and FIG. 7, the first color projection module 5 is disposed on the temperature measuring main body 1 and electrically connected to the signal control module 2, for projecting a first color light beam L1 onto the target area T100 of the object T by control of the signal-providing module 3 (such as cooperating with the signal control module 2). For example, the first color light beam L 1 can be a red laser beam for providing a red light spot mark. In addition, when the first color projection module 5 is configured to project the first color light beam L1, the first color light beam L1 projected by the first color projection module 5 can be transmitted along a first projecting optical axis Al so as to form a first light spot mark M1 that is projected onto the target area T100 of the object T. However, the aforementioned description is merely an example and is not meant to limit the scope of the present disclosure.

More particularly, referring to FIG. 3, FIG. 4, FIG. 6 and FIG. 8, the second color projection module 6 is disposed on the temperature measuring main body 1 and electrically connected to the signal control module 2, for projecting a second color light beam L2 onto the target area T100 of the object T by control of the signal-providing module 3 (such as cooperating with the signal control module 2). For example, the second color light beam L2 can be a green laser beam for providing a green light spot mark. In addition, when the second color projection module 6 is configured to project the second color light beam L2, the second color light beam L2 projected by the second color projection module 6 can be transmitted along a second projecting optical axis A2 so as to form a second light spot mark M2 that is projected onto the target area T100 of the object T. However, the aforementioned description is merely an example and is not meant to limit the scope of the present disclosure. It should be noted that a user cannot get close to the object T that has a higher temperature, and the red light spot mark projected on the object T having the higher temperature is not easily discernible to the user (that is to say, when the red light spot mark is projected on the object T having the higher temperature, the user cannot identify a position of the red light spot mark). Therefore, when the temperature of the object T (the object to be tested) is too high, the user can select the green light spot mark that is projected by the second color projection module 6 so as to clearly mark the target area T100 of the object T. In addition, the cost of the second color projection module 6 for projecting the green laser beam is about 5 to 10 times greater than the cost of the first color projection module 5 for projecting the red laser beam. However, the aforementioned description is merely an example and is not meant to limit the scope of the present disclosure. It should be noted that referring to FIG. 5 and FIG. 6, the first projecting optical axis Al and the temperature-sensing optical axis A can be inclined to each other and then coincide at a first coincidence point P1 (i.e., a first focal point as shown in FIG. 5), the second projecting optical axis A2 and the temperature-sensing optical axis A can be inclined to each other and then coincide at a second coincidence point P2 (i.e., a second focal point as shown in FIG, 6), and a distance from the first coincidence point P1 to the temperature-sensing module 4 is smaller than a distance from the second coincidence point P2 to the temperature-sensing module 4. For example, as shown in FIG. 5, when the first color light beam L1 projected by the first color projection module 5 passes through the first coincidence point P1, the first color light beam L1 on the first coincidence point P1 falls entirely within the temperature-sensing range R (that is to say, a light spot of the first color light beam L1 that is projected onto the first coincidence point P1 falls entirely within the temperature-sensing range R). As shown in FIG. 6, when the second color light beam L2 projected by the second color projection module 6 passes through the second coincidence point P2, the second color light beam L2 on the second coincidence point P2 falls entirely within the temperature-sensing range R (that is to say, a light spot of the second color light beam L2 that is projected on the second coincidence point P2 falls entirely within the temperature-sensing range R). Moreover, the first color light beam L1 projected by the first color projection module 5 has a first field angle (such as a first field of view (FOV)), the second color light beam L2 projected by the second color projection module 6 has a second field angle (such as a second field of view (FOV)), and the first field angle of the first color light beam L1 is greater than the second field angle of the second color light beam L2. However, the aforementioned description is merely an example and is not meant to limit the scope of the present disclosure.

More particularly, as shown in FIG. 3, in the first embodiment of the present disclosure, the signal-providing module 3 can be an automatic signal-providing module 3, and the signal-providing module 3 includes a distance-sensing chip 31 electrically connected to the signal control module 2. In addition, the distance-sensing chip 31 can be configured to provide distance information S1 to the signal control module 2 according to a distance from the temperature measuring device Z to the target area T100 of the object T (that is to say, the distance from the temperature measuring device Z to the target area T100 of the object T can be measured by the distance-sensing chip 31), and the signal-providing module 3 (such as cooperating with the signal control module 2) can be configured to turn on one of the first color projection module 5 and the second color projection module 6 according to the distance information S1;

For example, when a ratio of a measuring distance (D) to a measuring spot size (D) is less than 10 (D/S ratio being less than 10), and the distance from the temperature measuring device Z to the target area T100 of the object T is less than or equal to 1 m (meter), the first color projection module 5 can be turned on by control of the signal-providing module 3 (such as cooperating with the signal control module 2) so as to project the first light spot mark M1 onto the target area T100 of the object T. In addition, when the ratio of the measuring distance to the measuring spot size (e.g., a measuring area) is less than 10 (D/S ratio being less than 10), and the distance from the temperature measuring device Z to the target area T100 of the object T is greater than 1 m, the second color projection module 6 can be turned on by control of the signal-providing module 3 (such as cooperating with the signal control module 2) so as to project the second light spot mark M2 onto the target area T100 of the object T. Hence, the temperature of the target area T100 of the object T can be measured by the temperature-sensing module 4 selectively according to one of a first projecting position of the first light spot mark M1 provided by the first color projection module 5 and a second projecting position of the second light spot mark M2 provided by the second color projection module 6. However, the aforementioned description is merely an example and is not meant to limit the scope of the present disclosure.

For example, when the ratio of the measuring distance to the measuring spot size ranges from 20 to 30 (D/S ratio ranging from 20 to 30), and the distance from the temperature measuring device Z to the target area T100 of the object T is less than or equal to 2 m, the first color projection module 5 can be turned on by control of the signal-providing module 3 (such as cooperating with the signal control module 2) so as to project the first light spot mark M1 onto the target area T100 of the object T. In addition, when the ratio of the measuring distance to the measuring spot size ranges from 20 to 30 (D/S ratio ranging from 20 to 30), and the distance from the temperature measuring device Z to the target area T100 of the object T is greater than 2 m, the second color projection module 6 can be turned on by control of the signal-providing module 3 (such as cooperating with the signal control module 2) so as to project the second light spot mark M2 onto the target area T100 of the object T. Hence, the temperature of the target area T100 of the object T can be measured by the temperature-sensing module 4 selectively according to one of a first projecting position of the first light spot mark M1 provided by the first color projection module 5 and a second projecting position of the second light spot mark M2 provided by the second color projection module 6. However, the aforementioned description is merely an example and is not meant to limit the scope of the present disclosure.

For example, when the ratio of the measuring distance to the measuring spot size is greater than 50 (D/S ratio being greater than 50), and the distance from the temperature measuring device Z to the target area T100 of the object T is less than or equal to 3 m, the first color projection module 5 can be turned on by control of the signal-providing module 3 (such as cooperating with the signal control module 2) so as to project the first light spot mark M1 onto the target area T100 of the object T. In addition, when the ratio of the measuring distance to the measuring spot size is greater than 50 (D/S ratio being greater than 50), and the distance from the temperature measuring device Z to the target area T100 of the object T is greater than 3 m, the second color projection module 6 can be turned on by control of the signal-providing module 3 (such as cooperating with the signal control module 2) so as to project the second light spot mark M2 onto the target area T100 of the object T. Hence, the temperature of the target area T100 of the object T can be measured by the temperature-sensing module 4 selectively according to one of a first projecting position of the first light spot mark M1 provided by the first color projection module 5 and a second projecting position of the second light spot mark M2 provided by the second color projection module 6. However, the aforementioned description is merely an example and is not meant to limit the scope of the present disclosure.

### Second Embodiment

Referring to FIG. 9, a second embodiment of the present disclosure provides a temperature measuring device Z for providing light spot marks of different colors, which includes a temperature measuring main body (not shown), a signal control module 2, a signal-providing module 3, a temperature-sensing module 4, a first color projection module 5, and a second color projection module 6. Comparing FIG. 9 with FIG. 3, the biggest difference between the second embodiment and the first embodiment is that, in the second embodiment, the signal-providing module 3 includes a temperature-sensing chip 32 electrically connected to the signal control module 2. More particularly, the temperature-sensing chip 32 can be configured to provide temperature information S2 according to the temperature of the target area T100 of the object T (that is to say, the temperature of the target area T100 of the object T can be measured by the temperature-sensing chip 32), and the signal-providing module 3 (such as cooperating with the signal control module 2) can be configured to turn on one of the first color projection module 5 and the second color projection module 6 according to the temperature information S2.

For example, when the temperature of the target area T100 of the object T is less than or equal to 1000 K, the first color projection module 5 can be turned on by control of the signal-providing module 3 (such as cooperating with the signal control module 2) so as to project the first light spot mark M1 onto the target area T100 of the object T. In addition, when the temperature of the target area T100 of the object T is greater than 1000 K, the second color projection module 6 can be turned on by control of the signal-providing module 3 (such as cooperating with the signal control module 2) so as to project the second light spot mark M2 onto the target area T100 of the object T. Hence, the temperature of the target area T100 of the object T can be measured by the temperature-sensing module 4 selectively according to one of a first projecting position of the first light spot mark M1 provided by the first color projection module 5 and a second projecting position of the second light spot mark M2 provided by the second color projection module 6. However, the aforementioned description is merely an example and is not meant to limit the scope of the present disclosure.

It should be noted that the temperature-sensing chip 32 of the signal-providing module 3 and the temperature-sensing chip 40 of the temperature-sensing module 4 can be a same temperature-sensing chip or two different temperature-sensing chips. For example, the temperature-sensing chip 32 of the signal-providing module 3 and the temperature-sensing chip 40 of the temperature-sensing module 4 can function independent from each other, or the temperature-sensing chip 32 of the signal-providing module 3 can be replaced by the temperature-sensing chip 40 of the temperature-sensing module 4 (that is to say, the temperature-sensing chip 32 of the signal-providing module 3 can be omitted). However, the aforementioned description is merely an example and is not meant to limit the scope of the present disclosure.

### Third Embodiment

Referring to FIG. 10, a third embodiment of the present disclosure provides a temperature measuring device Z for providing light spot marks of different colors, which includes a temperature measuring main body (not shown), a signal control module 2, a signal-providing module 3, a temperature-sensing module 4, a first color projection module 5, and a second color projection module 6. Comparing FIG. 10 with FIG. 3, the biggest difference between the third embodiment and the first embodiment is that, in the third embodiment, the signal-providing module 3 can be a manual signal-providing module, and the signal-providing module 3 includes a manual changeover switch 33 electrically connected to the signal control module 2. More particularly, the user can manually operate the manual changeover switch 33 according to “distance information S1 that is obtained by determining a distance from the temperature measuring device Z to the target area T100 of the object T by the user”, or according to “temperature information S2 that is obtained by determining the temperature of the target area T100 of the object T by the user” (that is to say, the manual changeover switch 33 can be manually operated according to one of the distance information S1 and the temperature information S2 that can be determined or obtained according to user experience). Furthermore, the signal-providing module 3 can be configured to turn on one of the first color projection module 5 and the second color projection module 6 according to manual operation of the manual changeover switch 33 (such as cooperating with the signal control module 2).

For example, when the user determines that the distance from the temperature measuring device Z to the target area T100 of the object T is near (that is to say, the user feels that the target area T100 of the object T is close to the user), or that the temperature of the target area T100 of the object T is low (that is to say, the user feels that the temperature of the target area T100 of the object T is low for the user), the first color projection module 5 can be turned on by control of the signal-providing module 3 (such as cooperating with the signal control module 2) so as to project the first light spot mark M1 onto the target area T100 of the object T. In addition, when the user determines that the distance from the temperature measuring device Z to the target area T100 of the object T is far (that is to say, the user feels that the target area T100 of the object T is far from the user), or that the temperature of the target area T100 of the object T is high (that is to say, the user feels that the temperature of the target area T100 of the object T is high for the user), the second color projection module 6 can be turned on by control of the signal-providing module 3 (such as cooperating with the signal control module 2) so as to project the second light spot mark M2 onto the target area T100 of the object T. Hence, the temperature of the target area T100 of the object T can be measured by the temperature-sensing module 4 selectively according to one of a first projecting position of the first light spot mark M1 provided by the first color projection module 5 and a second projecting position of the second light spot mark M2 provided by the second color projection module 6. However, the aforementioned description is merely an example and is not meant to limit the scope of the present disclosure.

### Beneficial Effects of the Embodiments

In conclusion, in the temperature measuring device Z for providing light spot marks of different colors provided by the present disclosure, by virtue of “the signal-providing module 3 being disposed on the temperature measuring main body 1”, “the temperature-sensing module 4 being disposed on the temperature measuring main body 1, for measuring the temperature of the target area T100 of the object T”, “the first color projection module 5 being disposed on the temperature measuring main body 1, for projecting the first color light beam L1 onto the target area T100 of the object T by control of the signal-providing module 3 (such as cooperating with the signal control module 2)” and “the second color projection module 6 being disposed on the temperature measuring main body 1, for projecting the second color light beam L2 onto the target area T100 of the object T by control of the signal-providing module 3 (such as cooperating with the signal control module 2)”, the temperature of the target area T100 of the object T can be measured by the temperature-sensing module 4 selectively according to one of the first light spot mark M1 provided by the first color projection module 5 and the second light spot mark M2 provided by the second color projection module 6.

Furthermore, in the temperature measuring method for providing light spot marks of different colors provided by the present disclosure, by virtue of “providing the distance information S1 or the temperature information S2 according to the target area T100 that is selected from the object T”, “using the signal-providing module 3 to turn on one of the first color projection module 5 and the second color projection module 6 according to the distance information S1 or the temperature information S2” and “projecting the first color light beam L1 by the first color projection module 5 to form the first light spot mark M1 on the target area T100 of the object T when the first color projection module 5 is turned on, or projecting the second color light beam L2 by the second color projection module 6 to form the second light spot mark M2 on the target area T100 of the object T when the second color projection module 6 is turned on”, the temperature of the target area T100 of the object T can be measured by the temperature-sensing module 4 selectively according to one of the first light spot mark M1 provided by the first color projection module 5 and the second light spot mark M2 provided by the second color projection module 6.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A temperature measuring device for providing light spot marks of different colors, comprising:
a temperature measuring main body;
a signal control module disposed on the temperature measuring main body;
a signal-providing module disposed on the temperature measuring main body and electrically connected to the signal control module;
a temperature-sensing module disposed on the temperature measuring main body and electrically connected to the signal control module, wherein the temperature-sensing module is configured for measuring a temperature of a target area of an object in a temperature-sensing range;
a first color projection module disposed on the temperature measuring main body and electrically connected to the signal control module, wherein the first color projection module is configured for projecting a first color light beam onto the target area of the object by control of the signal-providing module; and
a second color projection module disposed on the temperature measuring main body and electrically connected to the signal control module, wherein the second color projection module is configured for projecting a second color light beam onto the target area of the object by control of the signal-providing module;
wherein the temperature-sensing range extends along a temperature-sensing optical axis, and heat radiation generated by the target area of the object is transmitted along the temperature-sensing optical axis and is then received by the temperature-sensing module;
wherein, when the first color projection module is configured to project the first color light beam, the first color light beam projected by the first color projection module is transmitted along a first projecting optical axis so as to form a first light spot mark that is projected onto the target area of the object;
wherein, when the second color projection module is configured to project the second color light beam, the second color light beam projected by the second color projection module is transmitted along a second projecting optical axis so as to form a second light spot mark that is projected onto the target area of the object;
wherein the first projecting optical axis and the temperature-sensing optical axis are inclined to each other and coincide at a first coincidence point, the second projecting optical axis and the temperature-sensing optical axis are inclined to each other and coincide at a second coincidence point, and a distance from the first coincidence point to the temperature-sensing module is smaller than a distance from the second coincidence point to the temperature-sensing module.

2. The temperature measuring device according to claim 1,
wherein the signal-providing module is one of an automatic signal-providing module and a manual signal-providing module, and the temperature-sensing module is a non-contact temperature-sensing module;
wherein the first color light beam is a red laser beam for providing a red light spot mark, and the second color light beam is a green laser beam for providing a green light spot mark;
wherein the first color light beam projected by the first color projection module has a first field angle, the second color light beam projected by the second color projection module has a second field angle, and the first field angle of the first color light beam is greater than the second field angle of the second color light beam;
wherein, when the first color light beam projected by the first color projection module passes through the first coincidence point, the first color light beam on the first coincidence point falls entirely within the temperature-sensing range;
wherein, when the second color light beam projected by the second color projection module passes through the second coincidence point, the second color light beam on the second coincidence point falls entirely within the temperature-sensing range.

3. The temperature measuring device according to claim 1,
wherein the signal-providing module is an automatic signal-providing module, and the signal-providing module includes a distance-sensing chip that is electrically connected to the signal control module;
wherein the distance-sensing chip is configured to provide distance information according to a distance from the temperature measuring device to the target area of the object, and the signal-providing module is configured to turn on one of the first color projection module and the second color projection module according to the distance information;
wherein, when a ratio of a measuring distance to a measuring spot size is less than 10, and the distance from the temperature measuring device to the target area of the object is less than or equal to 1 m, the first color projection module is turned on by control of the signal-providing module so as to project the first light spot mark onto the target area of the object;
wherein, when the ratio of the measuring distance to the measuring spot size is less than 10, and the distance from the temperature measuring device to the target area of the object is greater than 1 m, the second color projection module is turned on by control of the signal-providing module so as to project the second light spot mark onto the target area of the object;
wherein, when the ratio of the measuring distance to the measuring spot size ranges from 20 to 30, and the distance from the temperature measuring device to the target area of the object is less than or equal to 2 m, the first color projection module is turned on by control of the signal-providing module so as to project the first light spot mark onto the target area of the object;
wherein, when the ratio of the measuring distance to the measuring spot size ranges from 20 to 30, and the distance from the temperature measuring device to the target area of the object is greater than 2 m, the second color projection module is turned on by control of the signal-providing module so as to project the second light spot mark onto the target area of the object;
wherein, when the ratio of the measuring distance to the measuring spot size is greater than 50, and the distance from the temperature measuring device to the target area of the object is less than or equal to 3 m, the first color projection module is turned on by control of the signal-providing module so as to project the first light spot mark onto the target area of the object;
wherein, when the ratio of the measuring distance to the measuring spot size is greater than 50, and the distance from the temperature measuring device to the target area of the object is greater than 3 m, the second color projection module is turned on by control of the signal-providing module so as to project the second light spot mark onto the target area of the object.

4. The temperature measuring device according to claim 1, wherein the signal-providing module is an automatic signal-providing module, and the signal-providing module includes a temperature-sensing chip that is electrically connected to the signal control module;
wherein the temperature-sensing chip is configured to provide temperature information according to the temperature of the target area of the object, and the signal-providing module is configured to turn on one of the first color projection module and the second color projection module according to the temperature information;
wherein, when the temperature of the target area of the object is less than or equal to 1000 K, the first color projection module is turned on by control of the signal-providing module so as to project the first light spot mark onto the target area of the object;
wherein, when the temperature of the target area of the object is greater than 1000 K, the second color projection module is turned on by control of the signal-providing module so as to project the second light spot mark onto the target area of the object;
wherein the temperature-sensing module includes a temperature-sensing chip, and the temperature-sensing chip of the signal-providing module and the temperature-sensing chip of the temperature-sensing module are a same temperature-sensing chip or two different temperature-sensing chips.

5. The temperature measuring device according to claim 1,
wherein the signal-providing module is a manual signal-providing module, and the signal-providing module includes a manual changeover switch that is electrically connected to the signal control module;
wherein the manual changeover switch is manually operated by a user according to distance information that is obtained by determining a distance from the temperature measuring device to the target area of the object, or according to temperature information that is obtained by determining the temperature of the target area of the object, and the signal-providing module is configured to turn on one of the first color projection module and the second color projection module according to manual operation of the manual changeover switch;
wherein, when the user determines that the distance from the temperature measuring device to the target area of the object is near, or that the temperature of the target area of the object is low, the first color projection module is turned on by control of the signal-providing module so as to project the first light spot mark onto the target area of the object;
wherein, when the user determines that the distance from the temperature measuring device to the target area of the object is far, or that the temperature of the target area of the object is high, the second color projection module is turned on by control of the signal-providing module so as to project the second light spot mark onto the target area of the object.

6. A temperature measuring method for providing light spot marks of different colors, comprising:
providing distance information or temperature information according to a target area that is selected from an object;
using a signal-providing module to turn on one of a first color projection module and a second color projection module according to the distance information or the temperature information;
projecting a first color light beam by the first color projection module to form a first light spot mark on the target area of the object when the first color projection module is turned on, or projecting a second color light beam by the second color projection module to form a second light spot mark on the target area of the object when the second color projection module is turned on; and
measuring a temperature of the target area of the object by a temperature-sensing module according to one of the first light spot mark provided by the first color projection module and the second light spot mark provided by the second color projection module.

7. The temperature measuring method according to claim 6,
wherein the temperature-sensing module is configured to measure the temperature of the target area of the object in a temperature-sensing range, the temperature-sensing range extends along a temperature-sensing optical axis, and heat radiation generated by the target area of the object is transmitted along the temperature-sensing optical axis and is then received by the temperature-sensing module;
wherein, when the first color projection module is configured to project the first color light beam, the first color light beam projected by the first color projection module is transmitted along a first projecting optical axis so as to form the first light spot mark that is projected onto the target area of the object;
wherein, when the second color projection module is configured to project the second color light beam, the second color light beam projected by the second color projection module is transmitted along a second projecting optical axis so as to form the second light spot mark that is projected onto the target area of the object;
wherein the first projecting optical axis and the temperature-sensing optical axis are inclined to each other and coincide at a first coincidence point, the second projecting optical axis and the temperature-sensing optical axis are inclined to each other and coincide at a second coincidence point, and a distance from the first coincidence point to the temperature-sensing module is smaller than a distance from the second coincidence point to the temperature-sensing module.

8. The temperature measuring method according to claim 7,
wherein the signal-providing module is one of an automatic signal-providing module and a manual signal-providing module, and the temperature-sensing module is a non-contact temperature-sensing module;
wherein the first color light beam is a red laser beam for providing a red light spot mark, and the second color light beam is a green laser beam for providing a green light spot mark;
wherein the first color light beam projected by the first color projection module has a first field angle, the second color light beam projected by the second color projection module has a second field angle, and the first field angle of the first color light beam is greater than the second field angle of the second color light beam;
wherein, when the first color light beam projected by the first color projection module passes through the first coincidence point, the first color light beam on the first coincidence point falls entirely within the temperature-sensing range;
wherein, when the second color light beam projected by the second color projection module passes through the second coincidence point, the second color light beam on the second coincidence point falls entirely within the temperature-sensing range.

9. A temperature measuring device for providing light spot marks of different colors, comprising:
a temperature measuring main body;
a signal-providing module disposed on the temperature measuring main body;
a temperature-sensing module disposed on the temperature measuring main body, and configured for measuring a temperature of a target area of an object;
a first color projection module disposed on the temperature measuring main body, and configured for projecting a first color light beam onto the target area of the object by control of the signal-providing module; and
a second color projection module disposed on the temperature measuring main body, and configured for projecting a second color light beam onto the target area of the object by control of the signal-providing module.

10. The temperature measuring device according to claim 9,
wherein the temperature-sensing module is configured to measure the temperature of the target area of the object in a temperature-sensing range, the temperature-sensing range extends along a temperature-sensing optical axis, and heat radiation generated by the target area of the object is transmitted along the temperature-sensing optical axis and is then received by the temperature-sensing module;
wherein, when the first color projection module is configured to project the first color light beam, the first color light beam projected by the first color projection module is transmitted along a first projecting optical axis so as to form a first light spot mark that is projected onto the target area of the object;
wherein, when the second color projection module is configured to project the second color light beam, the second color light beam projected by the second color projection module is transmitted along a second projecting optical axis so as to form a second light spot mark that is projected onto the target area of the object;
wherein the first projecting optical axis and the temperature-sensing optical axis are inclined to each other and coincide at a first coincidence point, the second projecting optical axis and the temperature-sensing optical axis are inclined to each other and coincide at a second coincidence point, and a distance from the first coincidence point to the temperature-sensing module is smaller than a distance from the second coincidence point to the temperature-sensing module;
wherein the first color light beam projected by the first color projection module has a first field angle, the second color light beam projected by the second color projection module has a second field angle, and the first field angle of the first color light beam is greater than the second field angle of the second color light beam;
wherein, when the first color light beam projected by the first color projection module passes through the first coincidence point, the first color light beam on the first coincidence point falls entirely within the temperature-sensing range;
wherein, when the second color light beam projected by the second color projection module passes through the second coincidence point, the second color light beam on the second coincidence point falls entirely within the temperature-sensing range;
wherein the signal-providing module includes a distance-sensing chip that is electrically connected to the signal control module, the distance-sensing chip is configured to provide distance information according to a distance from the temperature measuring device to the target area of the object, and the signal-providing module is configured to turn on one of the first color projection module and the second color projection module according to the distance information;
wherein the signal-providing module includes a temperature-sensing chip that is electrically connected to the signal control module, the temperature-sensing chip is configured to provide temperature information according to the temperature of the target area of the object, and the signal-providing module is configured to turn on one of the first color projection module and the second color projection module according to the temperature information;
wherein the signal-providing module includes a manual changeover switch that is electrically connected to the signal control module, the manual changeover switch is manually operated by a user according to distance information that is obtained by determining a distance from the temperature measuring device to the target area of the object, or according to temperature information that is obtained by determining the temperature of the target area of the object, and the signal-providing module is configured to turn on one of the first color projection module and the second color projection module according to manual operation of the manual changeover switch.
